(19) United States
(12) Patent Application Publication
(10) Pub. No.: US 2026/0332392 A1
(43) Pub. Date: Oct. 22, 2026

(54) ENTERPRISE SPECIFIC HOME NETWORK KEY SUPPORT ON SIM OR ESIM

(71) Applicant: Cisco Technology, Inc., San Jose, CA (US)

(72) Inventors: Eugen Octavian NICOARA, Highlands Ranch, CO (US); Irfan ALI, San Francisco, CA (US); Charles WOLFINGER, Littleton, CO (US); Niraj R LONDHE, Denver, CO (US); Ravi Kiran GUNTUPALLI, Cumming, GA (US); Jeyaganesan CHANDRAN, Bengaluru (IN)

(21) Appl. No.: 19/185,598

(22) Filed: Apr. 22, 2025

(51) Int. Cl. H04L 9/08; H04L 9/14; H04L 9/40

(52) U.S. Cl. CPC H04L 9/0825; H04L 9/14; H04L 9/40

(57) ABSTRACT

The techniques herein provide for enterprise specific home network key support on Subscriber Identity Module (SIM) or embedded SIM (eSIM). In particular, in the context of private 5G deployments managed as cloud-controlled appliances, the techniques herein enable enterprise-specific Home Network Key (HNK) deployment and periodic rotation using over-the-air (OTA) updates. These techniques eliminate the need to store the private HNK corresponding to the public home network key in the SIM on edge nodes, thereby preventing the exposure of subscriber identities in the event of edge compromise.

### TECHNICAL FIELD

The present disclosure relates generally to computer networks, and, more particularly, to enterprise specific home network key support on Subscriber Identity Module (SIM) or embedded SIM (eSIM).

### BACKGROUND

In mobile communication networks, subscriber authentication and identity protection are critical components for ensuring privacy and network integrity. In 4G networks, the authentication procedure, as defined in 3GPP TS 29.272, section 5.2.3 (“Authentication Procedures”), involves the transmission of the user's identity (e.g., International Mobile Subscriber Identity or “IMSI”) in cleartext. This unencrypted transmission presents a significant privacy concern, as malicious actors intercepting the communication can easily obtain the real identity of subscribers.

The advent of 5G Core Network architecture introduced enhanced identity protection mechanisms, notably the use of Subscription Permanent Identifier (SUPI) and Subscription Concealed Identifier (SUCI), as described in 3GPP TS 23.501, section 5.9.2. SUCI enable the concealment of the subscriber permanent identity by encrypting the user's permanent identifier (SUPI) during the authentication procedure, in accordance with 3GPP TS 33.501, section 6.1.2 (“Initiation of authentication and selection of authentication method”) and section 6.1.3.2 (“Authentication procedure for 5G AKA”). Furthermore, section 5.2.5 (“Subscriber privacy”) of 3GPP TS 33.501 mandates that the SUPI should not be transmitted in cleartext over the Next Generation Radio Access Network (NG-RAN). However, whether this privacy measure is activated in a network is ultimately left to the discretion of the network operator.

When subscriber identity concealment is employed, a public and private key pair known as the Home Network Key (HNK) is utilized. This key pair is generated for a particular mobile network operator (MNO) and is shared by hundreds of (e)SIMs for an operator. An MNO may have more than one HNK key pairs, but each key pair is shared by a large set (typically hundreds of SIMs). The public key is stored on the SIM, which is then used by the SIM or the user equipment (UE) to encrypt the SUPI/IMSI and send it to the network in SUCI format, as outlined in 3GPP TS 23.003, section 2.2B (“Subscription Concealed Identifier (SUCI)”). Upon receipt of the authentication request at the Unified Data Management (UDM) function, if the SUCI is provided, the UDM forwards it to the Subscription Identifier De-concealing Function (SIDF), which uses the associated private key to decrypt the SUCI and recover the SUPI prior to authentication processing. The SIDF is a service integrated into the UDM.

In the context of private 5G deployments where the UDM is implemented at the network edge, this architecture introduces new challenges. Specifically, the HNK private key must be deployed locally on the edge to enable decryption of SUCI. However, since the private key is shared across multiple SIMs and not unique to a specific card, any compromise of the edge node risks exposing the private key, thereby jeopardizing the privacy of all subscribers completely unrelated to the compromised edge or enterprise network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates a simplified view of a 5G network;

FIG. 4 illustrates an example architecture for enterprise specific home network key support on Subscriber Identity Module (SIM) or embedded SIM (eSIM);

FIGS. 5A-5B illustrate an example call flow sequence for initial subscriber authentication and Home Network Key (HNK) provisioning;

FIG. 6 illustrates an example call flow sequence for key rotation;

FIG. 7 illustrates an example of edge vault state immediately after edge deployment;

FIG. 8 illustrates an example of the edge vault state after the first two HNK rotation events;

FIG. 9 illustrates an example of the edge vault state after the first 253 HNK rotation events;

FIG. 10 illustrates an example of the edge vault state after the first 256 HNK rotation events;

FIG. 11 illustrates an example of a full system and lifecycle for enterprise specific home network key support on SIM or eSIM in accordance with one or more embodiments herein; and

FIG. 12 illustrates an example procedure for enterprise specific home network key support on SIM or eSIM.

### DESCRIPTION OF EXAMPLE EMBODIMENTS

### Overview

According to one or more embodiments of the disclosure, enterprise specific home network key support on Subscriber Identity Module (SIM) or embedded SIM (eSIM) is provided herein. In particular, in one embodiment, an illustrative method herein may comprise: receiving, at a device, an indication that a mobile device has successfully completed a registration procedure using a first subscription concealed identifier; retrieving, by the device in response to the indication, a customer-specific home network key public key from a secure storage component; constructing, by the device, an over-the-air payload configured to cause a subscriber identity module of the mobile device to install the customer-specific home network key public key; transmitting, from the device, the over-the-air payload toward the mobile device; receiving, at the device, a confirmation of successful provisioning of the customer-specific home network key public key at the mobile device; and sending, from the device in response to the confirmation, a deregistration trigger to cause the mobile device to re-authenticate using a second subscription concealed identifier encrypted with the customer-specific home network key public key.

In another embodiment, the customer-specific home network key public key is periodically rotated to a new key, and the method further comprises: triggering an over-the-air message to cause the subscriber identity module of the mobile device to install the new key.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks.

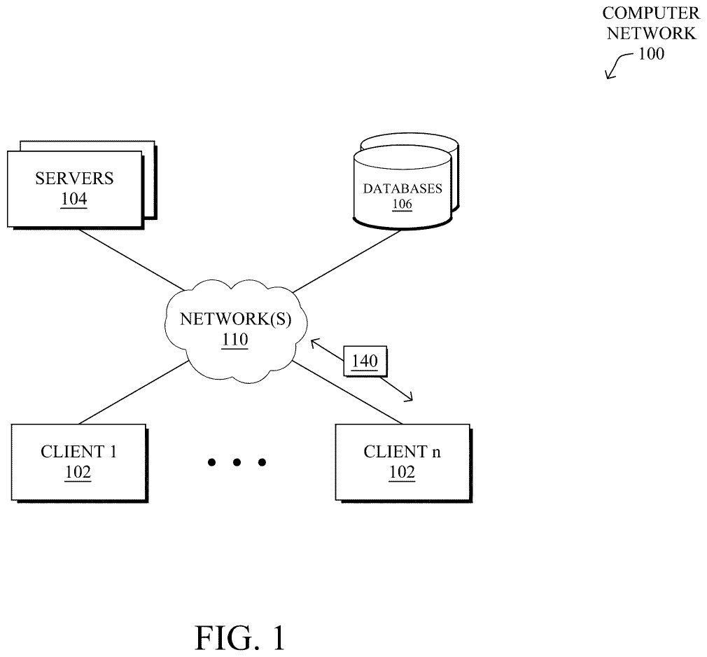

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

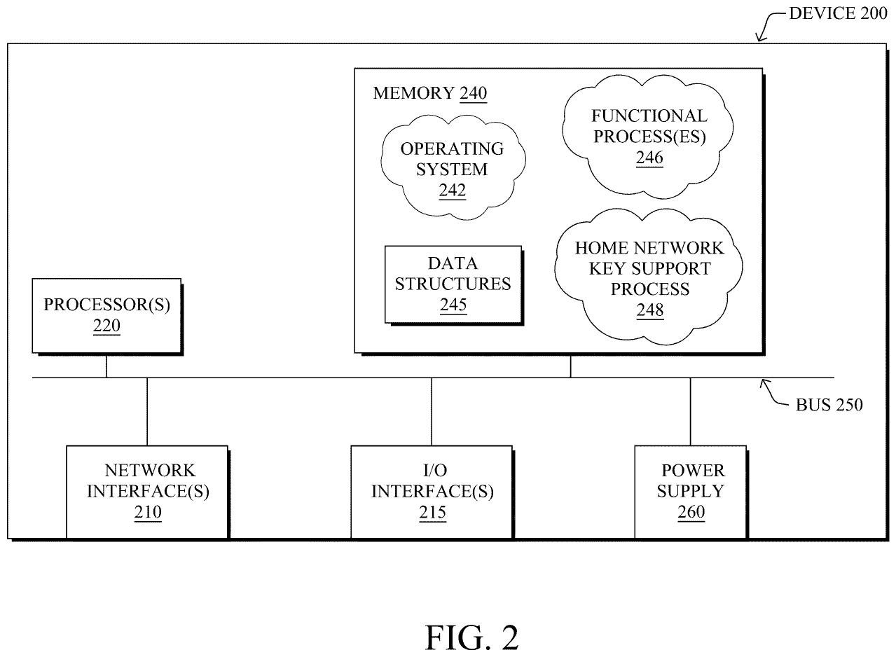

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242, portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a home network key support process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, one or more functional processes 246 and/or home network key support process (process 248) may include computer executable instructions that, when executed by processor(s) 220, cause device 200 to perform the techniques described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Cellular networks are the backbone of modern connectivity, enabling billions of devices worldwide to communicate with each other. At their core, cellular networks are systems of interconnected radio towers and base stations that provide wireless communication to mobile devices. These networks rely on a series of protocols and technologies to ensure reliable and efficient communication, from voice calls to high-speed internet access. Cellular networks are structured in layers, with the Radio Access Network (RAN) serving as the critical interface between user devices and the network core.

The evolution of cellular networks has been driven by the increasing demand for faster speeds, higher reliability, and the ability to support a growing variety of devices and services. Early networks, like 2G and 3G, focused primarily on voice communication and basic data transfer. With the advent of 4G, broadband internet access became a reality for mobile users, enabling high-speed data services like streaming and video calls. Currently, 5G is revolutionizing the landscape by promising ultra-reliable, low-latency communication, massive device connectivity, and enhanced mobile broadband speeds.

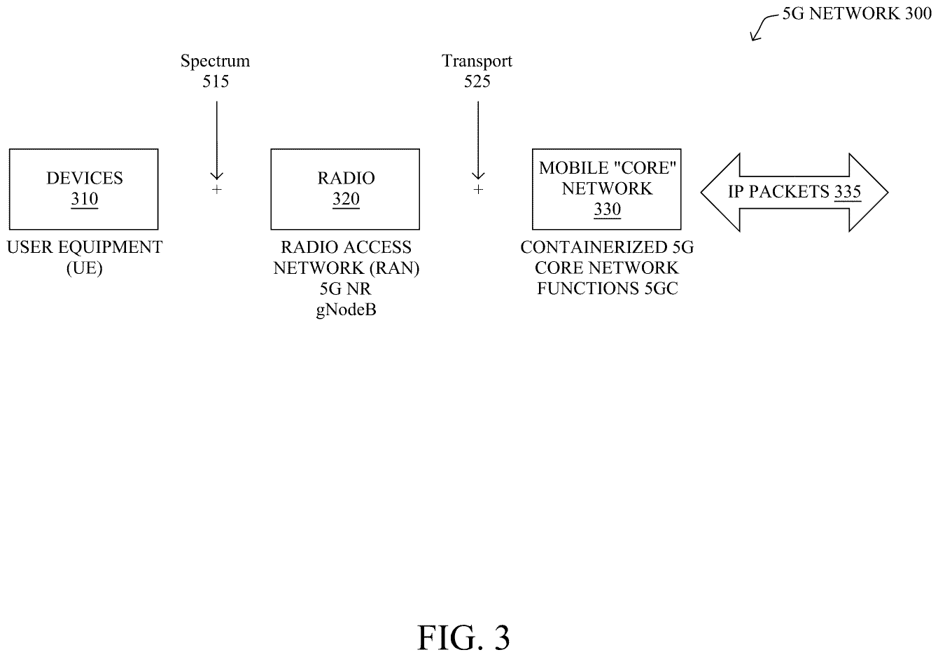

Briefly, FIG. 3 illustrates a simplified view of a 5G network 300. As shown, devices 310, such as user equipment (UE) (e.g., mobile phones), IoT devices, enterprise devices, etc., communicate (over spectrum 315) with a radio network 320, i.e., a radio access network (RAN), which may be composed of provisions to receive 5G “new radio” (NR) signals (e.g., through connections to gNode base stations (gNodeBs or gNBs)) and then translate those signals to IP packets and/or ethernet frames towards the 5G Evolved Packet Core (EPC). That is, radio network 320 then uses one or more transport protocols 325 to send the IP/ethernet data to a 5G core network 330, which may have containerized 5G core network functions (5GC) that utilize routers with IP/Segment routing capability to connect the data (e.g., IP packets 335) to the internet/servers/IoT servers/M2M (machine-to-machine) end devices (not shown for clarity).

### Enterprise Specific Home Network Key Support on Sim or Esim)

As noted above, protecting subscriber identity during authentication is a foundational element of secure mobile network operation. While 5G introduces mechanisms such as the Subscription Concealed Identifier (SUCI) to prevent transmission of a user's permanent identifier (SUPI) in cleartext, the effectiveness of this concealment depends on how and where the associated Home Network Key (HNK) is managed. In standard implementations, the HNK key pair—comprising a public key on the SIM and a private key used by the network—is generated by the SIM manufacturer and for a specific MNO or Private 5G network provider and is shared across all SIMs for that MNO or Private 5G network provider.

In 5G deployments where the Unified Data Management (UDM) function resides at the network edge, this architecture introduces a significant risk. Specifically, in order to decrypt the SUCI, the edge UDM must possess the HNK private key. However, because that key is common to very large number of SIMs issued, compromise of a single edge node may expose the identities of subscribers across multiple, unrelated deployments. This presents a serious privacy concern for enterprise customers who require strict isolation and control over identity-related cryptographic material.

Accordingly, there exists a need to eliminate the requirement of storing MNO or P5G network provider wide HNK private key on an edge device that performs authentication, thereby enhancing privacy and security in enterprise-specific or private 5G deployments.

The techniques herein, therefore, provide for enterprise specific home network key support on Subscriber Identity Module (SIM) or embedded SIM (eSIM). (In this disclosure the term SIM is used to refer to both SIM and eSIM.) In particular, in the context of private 5G deployments managed as cloud-controlled appliances, the techniques herein enable enterprise-specific Home Network Key (HNK) deployment and periodic rotation using over-the-air (OTA) updates. These techniques eliminate the need to store the private HNK corresponding to the public home network key in the SIM on edge nodes, thereby preventing the exposure of subscriber identities in the event of edge compromise. By leveraging a cloud-assisted authentication fallback and a coordinated mechanism for key update, the techniques herein support secure local authentication using customer-specific key pairs, while also providing flexible key lifecycle management without replacing physical SIM cards.

Specifically, according to one or more embodiments of the disclosure as described in detail below, an illustrative method herein may comprise: receiving, at a device, an indication that a mobile device has successfully completed a registration procedure using a first subscription concealed identifier; retrieving, by the device in response to the indication, a customer-specific home network key public key from a secure storage component; constructing, by the device, an over-the-air payload configured to cause a subscriber identity module of the mobile device to install the customer-specific home network key public key; transmitting, from the device, the over-the-air payload toward the mobile device; receiving, at the device, a confirmation of successful provisioning of the customer-specific home network key public key at the mobile device; and sending, from the device in response to the confirmation, a deregistration trigger to cause the mobile device to re-authenticate using a second subscription concealed identifier encrypted with the customer-specific home network key public key. In another embodiment, the customer-specific home network key public key is periodically rotated to a new key, and the method further comprises: triggering an over-the-air message to cause the subscriber identity module of the mobile device to install the new key.

Operationally, the techniques described address a critical vulnerability in environments, both public and private 5G deployment, but more specifically in private 5G environments where Unified Data Management (UDM) functions are deployed at the network edge. In conventional deployments, the MNO or P5G network provider provisions a default Home Network Key (HNK) public key onto the SIM card during manufacturing, while the corresponding private key is maintained by the network. In private 5G solutions, where the UDM may reside on an edge appliance, storing the shared vendor-provided private key locally creates a significant risk: if the edge is compromised, the attacker could potentially uncover the permanent identities (SUPIs) of all SIM users across multiple enterprises.

To resolve this, the techniques herein introduce a method for provisioning and rotating enterprise-specific Home Network Keys (HNK key pair), where the public key is delivered to the SIM via over-the-air (OTA) provisioning, and the enterprise-specific private key is stored securely at the edge (e.g., in a trusted vault or a Trusted Platform Module or “TPM”). This allows the SIM to encrypt its identity using an enterprise-specific key and enables the edge UDM to decrypt SUCIs locally—without ever exposing the MNO or Private 5G provider's private key outside the cloud.

As described in greater detail below, an illustrative high-level solution to not having the MNO's or Private 5G provider's private key of the Home Network Key (HNK) pair on the edge consists of the following steps:
1. Generate a customer specific HNK pair and provision it on the edge UDM.
2. Initial subscriber authentication via cloud subscription data management (SDM) (UE SUCI decrypted in cloud, using MNO or P5G network provider provided Home Network Key, HNK).
3. Update the HNK on SIM to the public key of the customer specific HNK via OTA.
4. Force UE to re-register using the new customer specific HNK.
5. All subsequent subscriber authentication via edge SDM (UE SUCI decrypted on edge, using customer specific HNK).

Note that the Private 5G (P5G) solution may be delivered as a cloud-managed appliance that runs all the needed core network functions (AMF, SMF, UPF) along with a local SDM (Subscriber Data Management) consisting of an authentication server function (AUSF), UDM, Unified Data Repository (UDR), etc. It has the capability to handle calls on the edge or to defer part of the handling to the Cloud SDM (Subscriber Data Management) solution.

In greater detail, the process begins with cloud-side onboarding of an enterprise customer, where a new HNK key pair is generated and stored in the secure configuration of each of the customer's edge nodes. The SIM card, as specified in 3GPP TS 31.102, section 4.4.11.8 “EFSUCI_Calc_Info (Subscription Concealed Identifier Calculation Information EF)”, supports up to 256 different HNK values (only the public key of the pair). Although all SIMs ship from the manufacturer with a single default HNK pre-installed (indexed at 98 in the non-limiting example shown), only one key is functionally used by the device at any given time, i.e., the one with the highest priority. That is, each key is identified by its index in the 0 . . . 255 range and it has an associated priority, although the 3GPP specification does not provide a mechanism for the UE to use multiple keys, so from a practical perspective only one key (having the highest priority) can and will be used.

When a UE first connects to the private 5G edge, it transmits a SUCI encrypted with the default SIM manufacturer HNK. The edge UDM, upon failing to find the corresponding private key locally, forwards the authentication request to the cloud-based Subscriber Data Management (SDM) platform, where the private key is available. Once the cloud SDM successfully authenticates the subscriber, the edge's SDM backend is notified to initiate an OTA message to update the SIM's HNK to the enterprise-specific public key (using the next available key index with higher priority). The OTA message includes properly structured Application Protocol Data Units (APDUs) to update the EFSUCI_Calc_Info file and can optionally include updates to routing indicators or service activation bits.

Upon confirmation of successful OTA delivery, the system forces a network-initiated deregistration to trigger a re-authentication using the newly installed HNK. This time, the UE sends a SUCI encrypted with the enterprise-specific key, and the edge UDM can complete authentication locally using the secure private key stored in its vault. From this point forward, all authentication requests for that UE can be handled entirely at the edge.

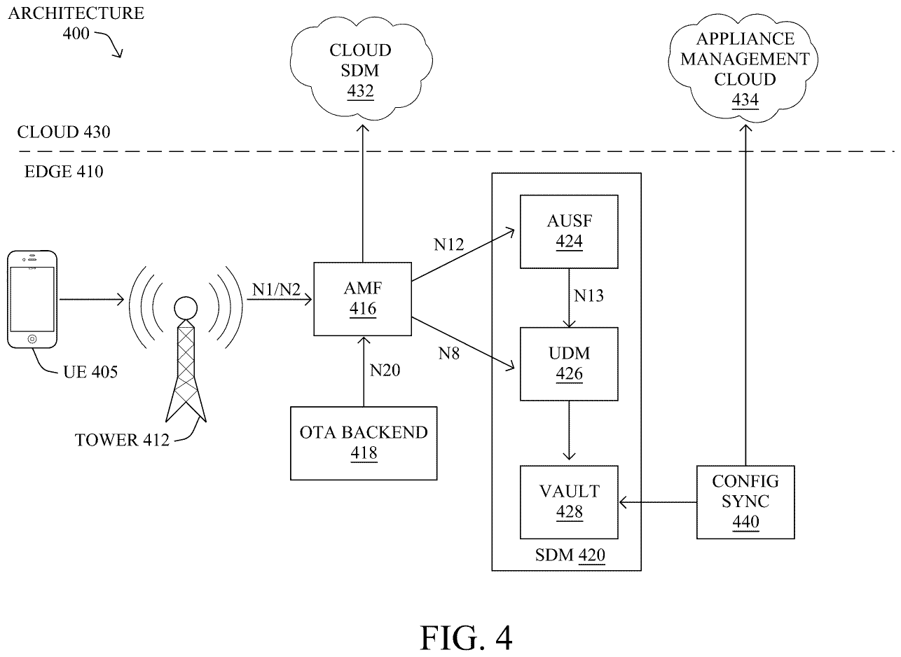

The overall system architecture is depicted in FIG. 4 (architecture 400), which illustrates the separation between the edge and cloud infrastructure, the involved network functions, and the communication interfaces that interconnect user equipment (UE 405), such as a cell phone, tablet, or other connected devices (user-based or automated, such as for IoT devices). At the edge 410, the system includes the Access and Mobility Function (AMF 416), the Subscriber Data Management (SDM) module (SDM 420) with its UDM 426 and AUSF 424, and a secure storage location or “vault” (vault 428) for key storage. The Over-The-Air (OTA) backend (OTA backend 418), also deployed at the edge, is responsible for constructing and delivering key provisioning messages to the UE 405. Communication between the UE and the network proceeds through tower 412 into standard 5G interfaces (e.g., N1, N2, N20, etc.), for the SDM 420 to handle signaling among internal components (e.g., optionally using service based interfaces or other internal component configurations not specifically shown for simplicity).

The cloud 430 hosts the Cloud SDM 432, which includes its own SDM functions and acts as a fallback for authentication when the edge lacks a necessary key. Also, Appliance Management Cloud 434 is an edge appliance management system, which includes the logic to onboard a new customer, deploy and manage the customer edges, as well as the mechanisms to rotate the customer specific HNK, as described below. The Appliance Management Cloud 434 also communicates with the vault 428 as described herein.

An initial step in Home Network Key (HNK) provisioning according to one or more embodiments of the techniques herein is to generate a key pair when the customer is onboarded. This would typically be a customer specific HNK and will be stored on the edge as part of the edge (re)deployment process. The key would be securely stored on the edge into the vault 428, TPM module, or other similar solution. This key would be identified by an index in the 1 . . . 255 range that is different from the index of the SIM manufacturer provided HNK stored on the SIM.

Note that in one embodiment herein, the customer specific HNK would be deployed on all the edge appliances of that customer so that the subscribers can move between edge appliances.

Once the edge has been provisioned and it is up and running, a subscriber attaching to this edge (e.g., as described in 3GPP TS 29.509, section 5.2.2.2.2 “5G AKA”) would send a SUCI value that has the current key index included (e.g., as described in 3GPP TS 23.003, section 2.2B “Subscription Concealed Identifier (SUCI)”). While trying to decrypt SUCI, the local UDM would try looking up the index in the local vault, but it would not find it because no key is provisioned on the edge for that index. Upon detecting this authentication failure (e.g., 3GPP TS 29.509, section 6.1.7.3 “Application Errors”), the AMF would proxy the authentication request to the cloud-hosted SDM where the subscriber would be successfully authenticated.

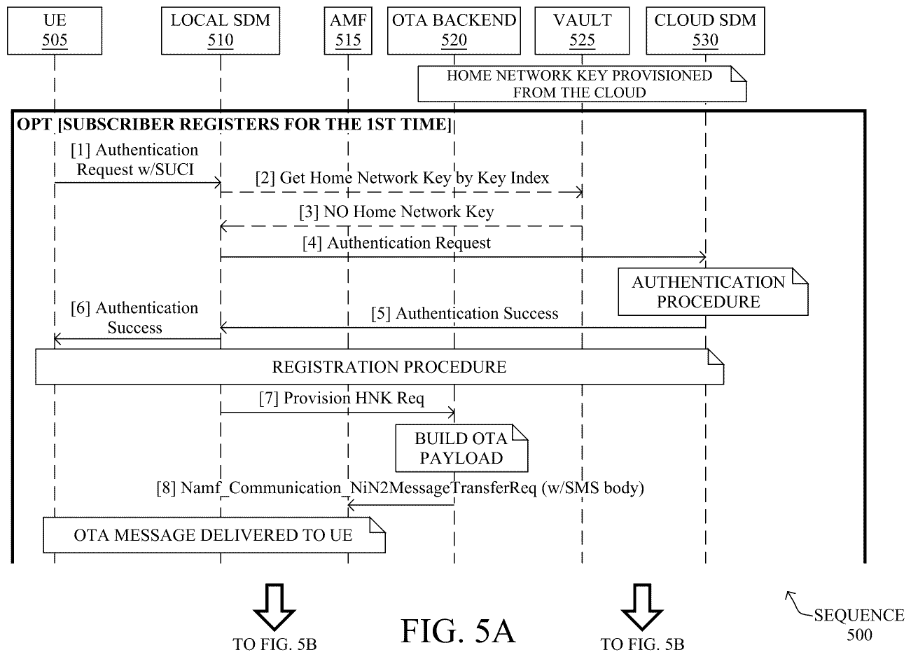

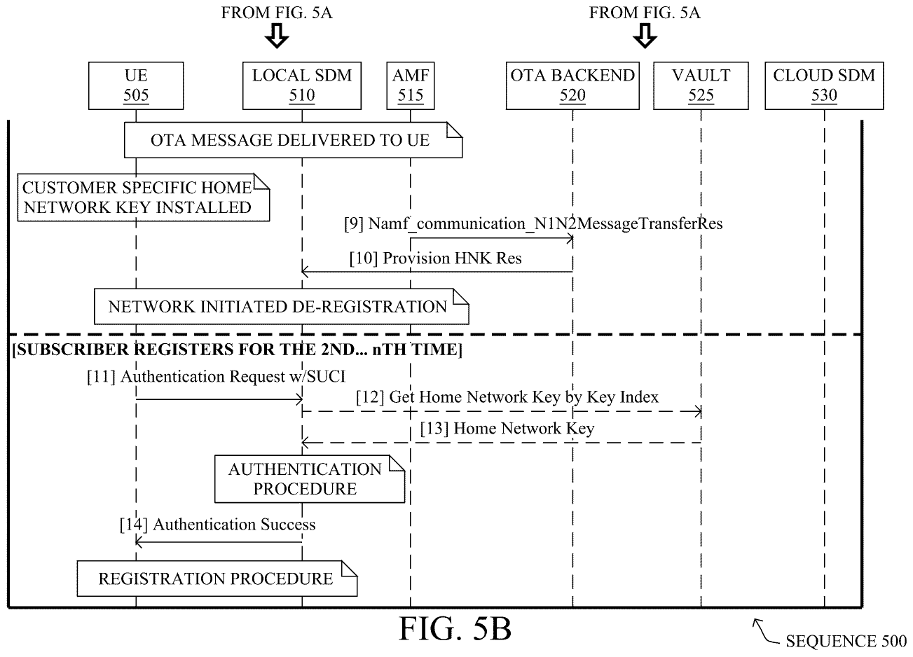

In particular, as shown in FIGS. 5A-5B, depicting an illustrative call flow sequence (sequence 500) for initial subscriber authentication and HNK provisioning (with the HNK provisioned from the cloud), the illustrative process herein begins when a UE 505 first registers with the private 5G network. The UE 505 transmits an authentication request (shown as step “[1]”) to the local SDM 510 containing a SUCI encrypted using the default vendor-provided public key, where the local SDM 510 attempts (step “[2]”) to get the HNK by the key index from the vault 525, accordingly. Because there is no corresponding HNK (step “[3]”), the SUCI cannot be decrypted, and as such, the local SDM 510 forwards (or proxies) the authentication request to the cloud SDM 530 (step “[4]”), which holds the vendor key and can perform the decryption and authentication according to its authentication procedure. Upon successful authentication, the local SDM 510 is notified of registration success (step “[5]”), which thereby informs the UE 505 (step “[6]”), and a registration procedure may then take place.

Upon detecting the successful completion of the registration procedure (e.g., as described in 3GPP TS 23.502, section 4.2.2.2.2 “General Registration” and section 4.13.3.1 “Registration procedures for [short message service (SMS)] over NAS”), the local SDM 510 (e.g., SBI endpoint which has acted as a proxy) notifies the OTA backend 520 to initiate the customer specific HNK provisioning (step “[7]”). The OTA backend retrieves the current HNK from the vault 525, builds an OTA message (customer specific HNK would have the highest priority) and sends it to the AMF 515 as an N1N2MessageTransfer request payload (e.g., as described in 3GPP TS 23.502, section 4.13.3.6 “MT SMS over NAS in CM-IDLE state via 3GPP access”) (step “[8]”).

Once the OTA message is delivered and processed by the UE, the SIM installs the enterprise-specific key. Upon receiving the successful provisioning confirmation from the UE 505 (steps “[9]” and “[10]”), the OTA backend 520 initiates the deregistration procedure as described in 3GPP TS 23.502, section 4.2.2.3.3 “Network-initiated Deregistration” to force the subscriber to (re)authenticate using the newly provisioned HNK.

Notably, the OTA payload may illustratively be built according to 3GPP TS 23.040, section 9.2.2.1 “SMS-DELIVER type” and would then include multiple APDUs (Application Protocol Data Units) needed to instruct the Universal Subscriber Identity Module (USIM) to write the HNK to the correct file: “SELECT ADFUSIM”, “SELECT DF5GS”, “SELECT EFSUCI_CALC_INFO”, “EFSUCI_Calc_Info”), “UPDATE BINARY” (with general reference 3GPP TS 31.102 for each of these APDUs, as will be appreciated by those skilled in the art. Other APDUs such as to update the routing indicator (e.g., “EFRouting_Indicator”) or to enable different services related to SUCI calculation (e.g., “EFUST (USIM Service Table)”) may also be included as needed.

The SUCI values sent as part of any subsequent authentication procedure (step “[11]”) (e.g., subscriber registering for the second through “nth” time) would include the index the of customer specific HNK key that exists in vault and the local SDM (UDM) would be able to decrypt the SUCI locally and further authenticate the subscriber (steps “[12]”, “[13]”, and “[14]”).

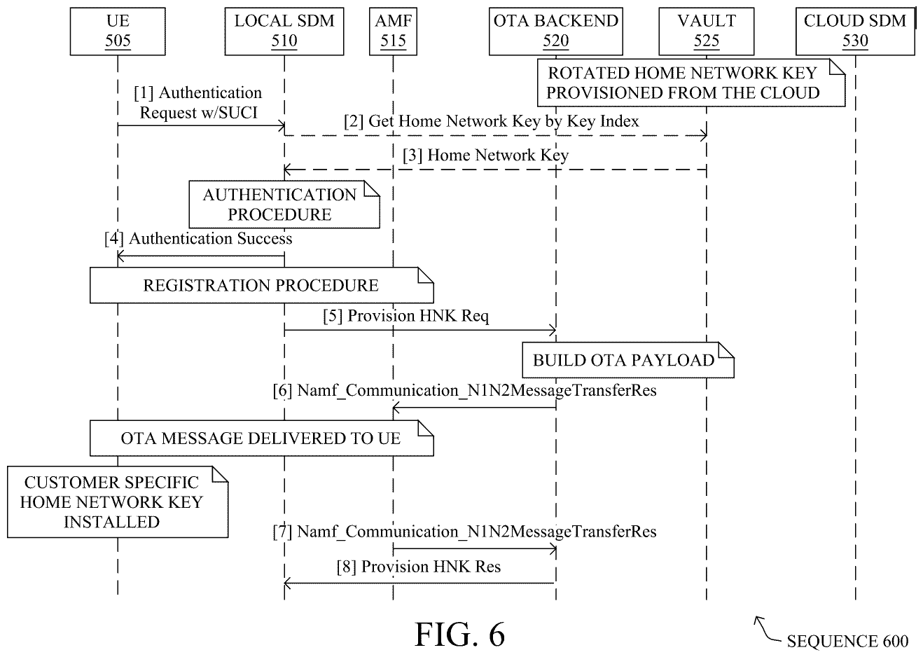

The system also supports periodic key rotation to ensure security hygiene and to mitigate risks in case of key compromise. The call flow to rotate a key, as illustratively shown in FIG. 6 (sequence 600), is similar with the one described above for Home Network Key Provisioning (illustrated in sequence 600 as steps “[1]” though “[8]” as shown), but with two key exceptions:
the trigger for provisioning the new key would be a SUCI that has been encrypted with a key that is not the latest one.
there is no need to force a subscriber that have authenticated with a HNK that is not the latest one to re-authenticate after the latest HNK key has been installed.

The key rotation procedure for the customer specific HNK would be periodically initiated by the Appliance Management Cloud where it would generate a new key pair. The new key pair would then be pulled by all the edges for that customer, stored in the edge vault using a different key index and the public part would be installed on all the SIMs on the next occasion. Notably, the index zero (used if and only if null protection scheme is used) and the one corresponding to the SIM vendor provided HNK should never be used for a customer specific HNK.

Regardless of the key rotation frequency (e.g., every 60, 90, or 120 days, or other configured values or on-demand rotation), multiple previous HNKs (up to 254) can and should be stored on the edge vault at the same time to allow subscribers that have not been active for a while to attach and install the latest HNK. Only one HNK shall be stored on the SIM at any given time. That is, the SIM always stores only the latest HNK public key, while the edge vault retains historical keys up to the current storage limit of 254 keys. If a SIM uses an outdated HNK (but one still stored in the vault), the edge UDM can still authenticate the UE. Only if a UE attempts to authenticate with a long-expired key no longer present in the edge vault would the authentication fail.

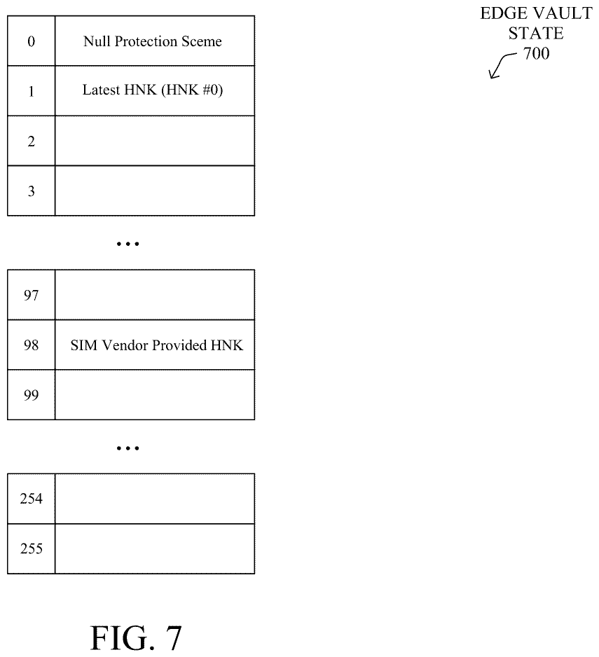

FIG. 7 illustrates an edge vault state 700 immediately after edge deployment, where only one enterprise-specific HNK is installed (e.g., “Latest HNK (HNK #0)”), at index 1), with all other entries empty, with the exceptions of index 0 (null protection scheme) and the SIM vendor's key at index 98 (which is no longer prioritized for use, as described above).

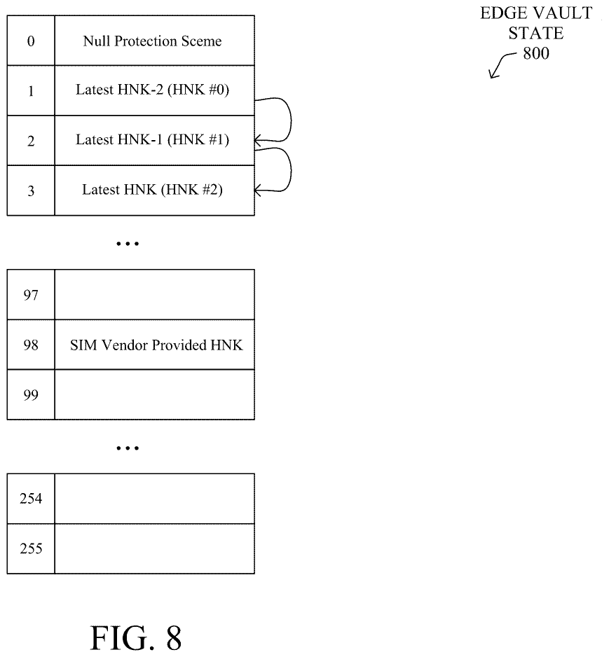

After this initial state where only one enterprise key is present, FIG. 8 illustrates an edge vault state 800 after the first two HNK rotation events. In particular, as key rotation begins, newer HNKs are added with higher priority. Assume that a new key “HNK #1” was added, and then later a new “HNK #2”. As such, the indexes 1-3 would now appear in FIG. 8 as:
1. “Latest HNK-2 (HMK #0)” (i.e., the original HNK from edge vault state 700 above);
2. “Latest HNK-1 (HMK #1)” (i.e., the intermediate HNK added during a first key rotation);
3. “Latest HNK (HMK #2)” (i.e., the latest rotated HNK).

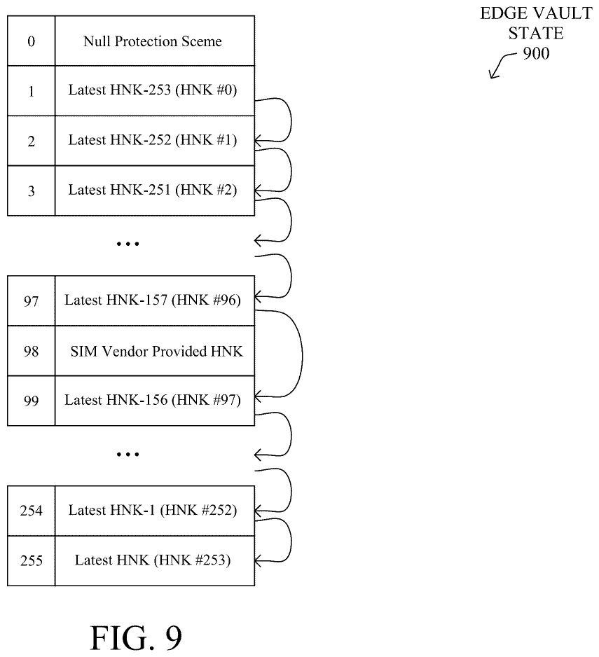

FIG. 9 demonstrates a maximum state of key rotations (edge vault state 900) after the first two hundred fifty three HNK rotation events in this manner, where the vault is now fully populated. As shown, the Latest HNK is now HNK #253 (at index 255). Here, each key is still accessible by its index, allowing the network to authenticate using slightly outdated keys.

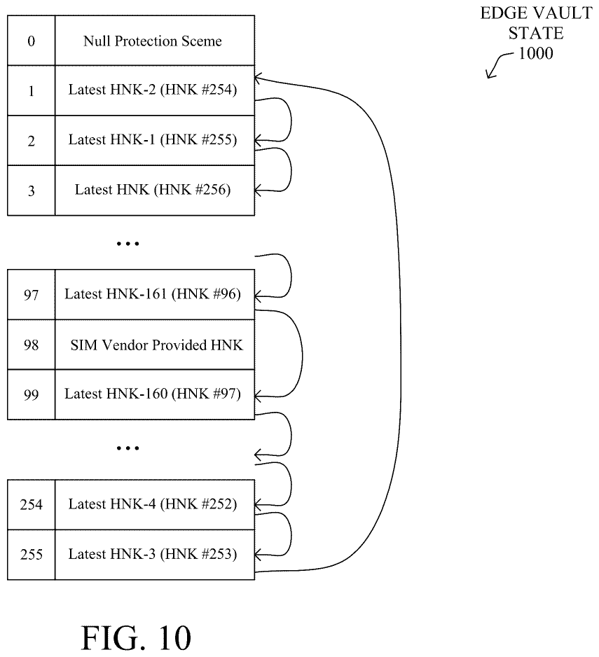

Eventually, after the number of key rotations reaches the vault limit (as in FIG. 9), earlier keys begin being overwritten. FIG. 10, for instance, demonstrates the edge vault state after the first two hundred fifty six HNK rotation events (edge vault state 1000), i.e., three more keys added after the edge vault state 900 above. Now, the most recent key rotation results in the Latest HNK (HNK #256) being stored at index 3 (with the current highest priority), overwriting the previous key stored at that index. It can thus be seen that the original three keys have been lost (i.e., HNK #0, HNK #1, and HNK #2), and any attempt to use one of these outdated keys would fail to authenticate (i.e., SUCI encrypted with those keys will not be decrypted and the corresponding authentication requests will fail).

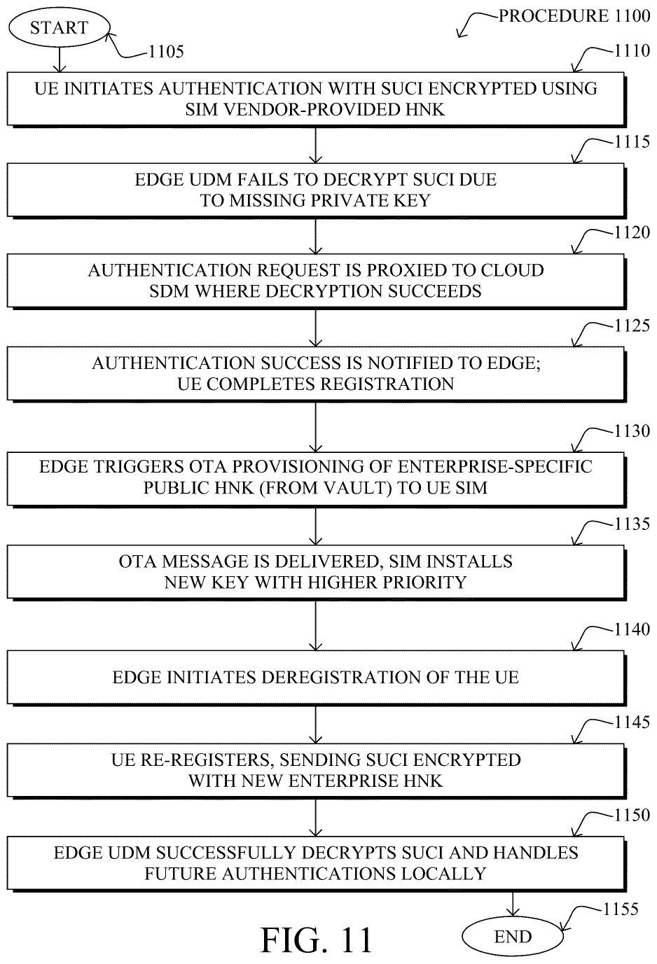

An example of the full system and lifecycle described herein in accordance with one or more embodiments herein can be conceptually summarized in FIG. 11, which presents a high-level process flow (procedure 1100). For example, the procedure 1100 may start at step 1105, and continues to step 1110, where, as described in greater detail above, when a user equipment (UE) initiates its first connection to an enterprise-deployed private 5G network, it sends a SUCI encrypted using the SIM vendor's default Home Network Key (HNK). In step 1115, since this default key's private counterpart is not stored on the edge for security reasons, the local UDM fails to decrypt the SUCI. In step 1120, this triggers a fallback mechanism where the request is proxied to the cloud-based SDM, which holds the private key.

Upon successful authentication and registration in step 1125, the edge SDM signals the OTA backend to initiate a provisioning procedure in step 1130. A customer-specific HNK public key is retrieved from a secure vault and embedded in a properly formatted OTA message using standard APDU instructions. This message is sent via the AMF and delivered to the UE in step 1135, which then updates its SIM to use the new key (e.g., with higher priority). To complete the transition, the edge initiates a deregistration of the UE in step 1140, prompting it to re-register. The next authentication attempt in step 1145 then includes a SUCI encrypted with the enterprise-specific key, which the edge UDM can now decrypt and authenticate locally in step 1150.

This process supports future key rotations by retaining multiple prior keys in the vault, allowing seamless key migration without SIM replacement. Procedure 1100 may then end at step 1155, with the option for further key updates as described above, accordingly.

This architecture leverages cloud resources only when required and eliminates the risk associated with storing a network-wide private key at the edge. It also provides scalable, OTA-managed key rotation without requiring physical SIM replacement. The separation of initial onboarding and local runtime authentication provides enterprise users (including highly sensitive customers such as military organizations) with the ability to isolate their subscriber identities from all others, while remaining compatible with existing 5G infrastructure and standards.

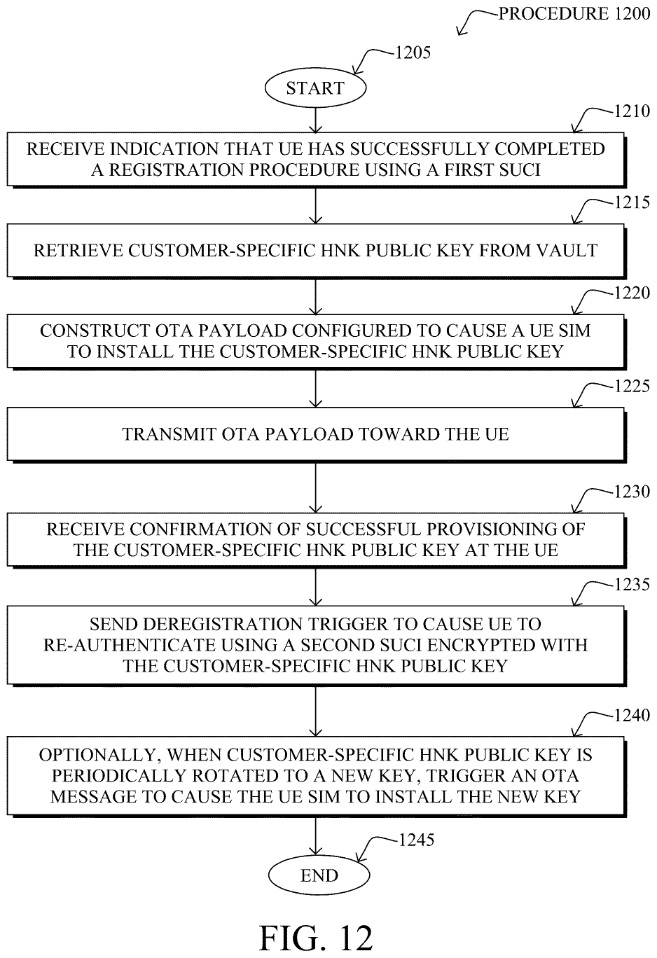

In closing, FIG. 12 illustrates another example simplified procedure for enterprise specific home network key support on SIM or eSIM in accordance with one or more embodiments described herein, particularly from the perspective of an OTA backend device or other similarly configured device. For example, a non-generic, specifically configured device (e.g., device 200, an apparatus) may perform procedure 1200 by executing stored instructions (e.g., process 248). The procedure 1200 may start at step 1205, and continues to step 1210, where, as described in greater detail above, an indication is received that a mobile device (e.g., a user equipment device or UE) has successfully completed a registration procedure using a first subscription concealed identifier (SUCI). As noted above, the indication may correspond to successful authentication of the mobile device by a cloud-hosted subscriber data management (SDM) based on a subscriber identity module (SIM) vendor-provided home network key (HNK). As also noted, the indication may be received from an SDM function.

In step 1215, in response to the indication, the process may receive a customer-specific HNK public key from a secure storage component, such as a vault or TPM deployed at a network edge appliance. As such, in step 1220, the techniques herein may then construct an OTA payload (e.g., an SMS payload) configured to cause a UE SIM (e.g., SIM/eSIM/USIM) to install the customer-specific HNK public key. In one embodiment as mentioned above, the OTA payload may comprise a plurality of APDUs configured to cause the UE SIM to install the customer-specific HNK public key (e.g., with a highest priority index).

In step 1225 the OTA payload is transmitted toward the UE, illustratively via an access and mobility function (e.g., as part of an N1N2MessageTransfer request), as noted above. In step 1230, the device may then receive confirmation of successful provisioning of the customer-specific HNK public key at the UE, and in response, in step 1235, sends a deregistration trigger to cause the UE to re-authenticate using a second SUCI encrypted with the customer-specific HNK public key, accordingly.

Optionally, in step 1240, when the customer-specific home network key public key is periodically rotated to a new key, the process may further comprise triggering an OTA message to cause the UE SIM to install the new key. (As noted above, the UE SIM is configured with only a latest key, and the secure storage component retains a plurality of previously rotated corresponding private keys.)

Procedure 1200 may end at step 1245.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In particular, in some implementations, an illustrative method herein may comprise: receiving, at a device, an indication that a mobile device has successfully completed a registration procedure using a first subscription concealed identifier; retrieving, by the device in response to the indication, a customer-specific home network key public key from a secure storage component; constructing, by the device, an over-the-air payload configured to cause a subscriber identity module of the mobile device to install the customer-specific home network key public key; transmitting, from the device, the over-the-air payload toward the mobile device; receiving, at the device, a confirmation of successful provisioning of the customer-specific home network key public key at the mobile device; and sending, from the device in response to the confirmation, a deregistration trigger to cause the mobile device to re-authenticate using a second subscription concealed identifier encrypted with the customer-specific home network key public key.

In one embodiment the secure storage component is deployed at a network edge appliance and comprises one of either a vault or a trusted platform module.

In one embodiment, the indication corresponds to successful authentication of the mobile device by a cloud-hosted subscriber data management based on a subscriber identity module vendor-provided home network key.

In one embodiment, the subscriber identity module of the mobile device comprises one of either an embedded subscriber identity module or a universal subscriber identity module.

In one embodiment, the mobile device is a user equipment device.

In one embodiment, the indication is received from a subscriber data management function.

In one embodiment, the over-the-air payload is a short message service payload.

In one embodiment, the over-the-air payload comprises a plurality of application protocol data units configured to cause the subscriber identity module of the mobile device to install the customer-specific home network key public key.

In one embodiment, the over-the-air payload comprises a plurality of application protocol data units configured to cause the subscriber identity module of the mobile device to install the customer-specific home network key public key with a highest priority index.

In one embodiment, the over-the-air payload is transmitted toward the mobile device via an access and mobility function. In one embodiment, the over-the-air payload is transmitted toward the mobile device via the access and mobility function as part of an N1N2MessageTransfer request.

In one embodiment, the device is an over-the-air backend device.

In one embodiment, the customer-specific home network key public key is periodically rotated to a new key, and the method further comprises: triggering an over-the-air message to cause the subscriber identity module of the mobile device to install the new key. In one embodiment, the subscriber identity module of the mobile device is configured with only a latest key, and the secure storage component retains a plurality of previously rotated corresponding private keys.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: receiving an indication that a mobile device has successfully completed a registration procedure using a first subscription concealed identifier; retrieving, in response to the indication, a customer-specific home network key public key from a secure storage component; constructing an over-the-air payload configured to cause a subscriber identity module of the mobile device to install the customer-specific home network key public key; transmitting the over-the-air payload toward the mobile device; receiving a confirmation of successful provisioning of the customer-specific home network key public key at the mobile device; and sending, in response to the confirmation, a deregistration trigger to cause the mobile device to re-authenticate using a second subscription concealed identifier encrypted with the customer-specific home network key public key.

In still other implementations, a tangible, non-transitory, computer-readable medium storing program instructions that cause a device to execute a process comprising: receiving an indication that a mobile device has successfully completed a registration procedure using a first subscription concealed identifier; retrieving, in response to the indication, a customer-specific home network key public key from a secure storage component; constructing an over-the-air payload configured to cause a subscriber identity module of the mobile device to install the customer-specific home network key public key; transmitting the over-the-air payload toward the mobile device; receiving a confirmation of successful provisioning of the customer-specific home network key public key at the mobile device; and sending, in response to the confirmation, a deregistration trigger to cause the mobile device to re-authenticate using a second subscription concealed identifier encrypted with the customer-specific home network key public key.

The techniques described herein, therefore, provide for enterprise specific home network key support on SIM or eSIM. In particular, the techniques described provide several critical advantages in the deployment of secure private 5G networks. By avoiding the storage of SIM vendor-provided HNK private keys at the edge, the techniques herein reduce the risk of mass subscriber identity compromise in the event of edge node breach. The use of enterprise-specific HNKs not only improves isolation between tenants but also enables regulatory and policy compliance for sensitive deployments, such as military or governmental use cases.

Moreover, the ability to push new public keys to SIMs using standardized OTA messaging ensures that no physical SIM replacement is required, dramatically simplifying lifecycle management. This solution aligns with the flexibility offered by eSIMs while still being applicable to traditional SIM hardware. Support for periodic key rotation further enhances security posture, and the ability to fallback to cloud-based authentication ensures continuity of service, even during key transitions. Overall, the described architecture bridges practical deployment realities with strong cryptographic safeguards, enhancing trust in enterprise cellular infrastructure.

Notably, though many aspects of the techniques herein are configured to align with existing standards (e.g., SUCI format, OTA message structure, and 5G AKA procedures), the coordination between initial authentication failure at the edge, fallback to cloud, OTA-based SIM rekeying, and secure edge-side decryption using rotated, enterprise-specific keys has not been previously described in this coordinated manner.

Illustratively, the techniques described herein may be performed by hardware, software, and/or firmware, (e.g., an “apparatus”) such as in accordance with the home network key support process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
receiving, at a device, an indication that a mobile device has successfully completed a registration procedure using a first subscription concealed identifier;
retrieving, by the device in response to the indication, a customer-specific home network key public key from a secure storage component;
constructing, by the device, an over-the-air payload configured to cause a subscriber identity module of the mobile device to install the customer-specific home network key public key;
transmitting, from the device, the over-the-air payload toward the mobile device;
receiving, at the device, a confirmation of successful provisioning of the customer-specific home network key public key at the mobile device; and
sending, from the device in response to the confirmation, a deregistration trigger to cause the mobile device to re-authenticate using a second subscription concealed identifier encrypted with the customer-specific home network key public key.

2. The method of claim 1, wherein the secure storage component is deployed at a network edge appliance and comprises one of either a vault or a trusted platform module.

3. The method of claim 1, wherein the indication corresponds to successful authentication of the mobile device by a cloud-hosted subscriber data management based on a subscriber identity module vendor-provided home network key.

4. The method of claim 1, wherein the subscriber identity module of the mobile device comprises one of either an embedded subscriber identity module or a universal subscriber identity module.

5. The method of claim 1, wherein the mobile device is a user equipment device.

6. The method of claim 1, wherein the indication is received from a subscriber data management function.

7. The method of claim 1, wherein the over-the-air payload is a short message service payload.

8. The method of claim 1, wherein the over-the-air payload comprises a plurality of application protocol data units configured to cause the subscriber identity module of the mobile device to install the customer-specific home network key public key.

9. The method of claim 1, wherein the over-the-air payload comprises a plurality of application protocol data units configured to cause the subscriber identity module of the mobile device to install the customer-specific home network key public key with a highest priority index.

10. The method of claim 1, wherein the over-the-air payload is transmitted toward the mobile device via an access and mobility function.

11. The method of claim 10, wherein the over-the-air payload is transmitted toward the mobile device via the access and mobility function as part of an N1N2MessageTransfer request.

12. The method of claim 1, wherein the device is an over-the-air backend device.

13. The method of claim 1, wherein the customer-specific home network key public key is periodically rotated to a new key, the method further comprising:
triggering an over-the-air message to cause the subscriber identity module of the mobile device to install the new key.

14. The method of claim 13, wherein the subscriber identity module of the mobile device is configured with only a latest key, and wherein the secure storage component retains a plurality of previously rotated corresponding private keys.

15. An apparatus, comprising:
one or more network interfaces to communicate with a network;
a processor coupled to the one or more network interfaces and configured to execute one or more processes; and
a memory configured to store a process that is executable by the processor, the process comprising:
receiving an indication that a mobile device has successfully completed a registration procedure using a first subscription concealed identifier;
retrieving, in response to the indication, a customer-specific home network key public key from a secure storage component;
constructing an over-the-air payload configured to cause a subscriber identity module of the mobile device to install the customer-specific home network key public key;
transmitting the over-the-air payload toward the mobile device;
receiving a confirmation of successful provisioning of the customer-specific home network key public key at the mobile device; and
sending, in response to the confirmation, a deregistration trigger to cause the mobile device to re-authenticate using a second subscription concealed identifier encrypted with the customer-specific home network key public key.

16. The apparatus of claim 15, wherein the indication corresponds to successful authentication of the mobile device by a cloud-hosted subscriber data management based on a subscriber identity module vendor-provided home network key.

17. The apparatus of claim 15, wherein the indication is received from a subscriber data management function.

18. The apparatus of claim 15, wherein the apparatus is an over-the-air backend device.

19. The apparatus of claim 15, wherein the customer-specific home network key public key is periodically rotated to a new key, the process further comprising:
triggering an over-the-air message to cause the subscriber identity module of the mobile device to install the new key.

20. A tangible, non-transitory, computer-readable medium storing program instructions that cause a device to execute a process comprising:
receiving an indication that a mobile device has successfully completed a registration procedure using a first subscription concealed identifier;
retrieving, in response to the indication, a customer-specific home network key public key from a secure storage component;
constructing an over-the-air payload configured to cause a subscriber identity module of the mobile device to install the customer-specific home network key public key;
transmitting the over-the-air payload toward the mobile device;
receiving a confirmation of successful provisioning of the customer-specific home network key public key at the mobile device; and
sending, in response to the confirmation, a deregistration trigger to cause the mobile device to re-authenticate using a second subscription concealed identifier encrypted with the customer-specific home network key public key.
